(19) United States
(12) Patent Application Publication
(10) Pub. No.: US 2025/0335882 A1
(43) Pub. Date: Oct. 30, 2025

(54) METHOD OF PROCESSING SECONDHAND TEXTILES FOR FURTHER UTILIZATION

(71) Applicant: Harvest Nano Inc., Ann Arbor, MI (US)

(72) Inventors: Refael Aharon, Ann Arbor, MI (US); Nicholas Carlson, Spring Lake, MI (US); Ryan Risley, Muskegon, MI (US); Jeanette Hoyer, Norton Shores, MI (US)

(21) Appl. No.: 19/190,841

(22) Filed: Apr. 28, 2025

Related U.S. Application Data
(60) Provisional application No. 63/639,651, filed on Apr. 28, 2024.

(51) Int. Cl. G06Q 10/30; G06T 7/00

(52) U.S. Cl. CPC G06Q 10/30; G06T 7/0002; G06T 2207/10048

(57) ABSTRACT

A method of processing secondhand textiles for further utilization includes providing a secondhand textile, inspecting and screening the secondhand textile, with at least inspection and screening hardware, to determine attribute data of the secondhand textile, analyzing the determined attribute data of the secondhand textile, and determining if the secondhand textile is salable or non-salable based on at least the analyzing of the determined attribute data of the secondhand textile.

### CROSS-REFERENCE TO RELATED APPLICATIONS

The present application claims the benefit of priority to U.S. Provisional Patent Application Ser. No. 63/639,651, filed on Apr. 28, 2024, the disclosure of which is hereby incorporated by reference in its entirety for all purposes.

### TECHNICAL FIELD

The present disclosure relates generally to textile circularity and sustainability, and more particularly to a method of processing secondhand textiles for further utilization.

### BACKGROUND

This section provides background information related to the present disclosure which is not necessarily prior art.

The resale of secondhand textiles, such as various kinds of secondhand clothing, has evolved over the years and dates back to ancient civilizations, where secondhand clothing was often handed down within communities or spun into new fibers. For example, in medieval Europe, secondhand clothing markets emerged as a way for the wealthier population to dispose of unwanted clothing, which were then sold to the lower-income population.

In the 18th and 19th centuries, the Industrial Revolution led to various textiles being mass-produced, thus making new clothing more affordable and accessible to a larger portion of the population, especially in more developed countries. As a result of more new clothing being mass-produced, the resale of secondhand clothing became more widespread, with the emergence of such entities as pawnshops, flea markets, and charitable organizations selling donated secondhand clothing.

In the 20th century, with the rise of the fashion industry and consumer culture, clothing styles and fashion trends began to change rapidly. This led to increased turnover of clothing and a growing market for secondhand clothing, as people sought more affordable alternatives to keep up with such aforementioned fashion trends. Such entities as thrift stores, charity shops, and other entities gained popularity during the early to mid-20th century, providing affordable secondhand clothing options while also serving as fundraising outlets for some charitable organizations. Such aforementioned entities advantageously played a meaningful role in democratizing fashion and reducing wasted secondhand clothing (i.e., textile waste) by extending the overall lifecycle of secondhand clothing.

In more recent years, the internet and digital platforms, including various online marketplaces, have revolutionized the resale market globally, making it more convenient for the general population to buy and sell secondhand clothing online. Examples of such online marketplaces may include eBay®, Poshmark®, ThredUp®, Depop®, and Goodwill® (i.e., selling donated secondhand clothing and other products online).

Today, when secondhand clothing and other secondhand textiles are donated, such as to a donation center or retail store of a non-profit organization or other entity, trained employees typically manually process such donated secondhand clothing. In this regard, manually processing donated secondhand clothing and other secondhand textiles is unfortunately associated with various challenges and limitations. For example, trained employees typically manually handle and visually inspect a manufacturer tag of each piece of secondhand clothing to obtain attributes such as size, brand, gender, and material composition. Such visual manufacturer tag inspection may be relatively time-consuming. Moreover, if a particular piece of secondhand clothing does not include a manufacturer tag or the manufacturer tag is unreadable, such aforementioned attributes are often unable to be determined. Since factors such as brand reputation, style, current fashion trends, and seasonality are considered when determining potential resale value of the secondhand clothing, it is beneficial to accurately obtain as many attributes of the secondhand clothing as possible so as to potentially increase the resale value thereof. Moreover, trained employees typically manually handle and visually inspect each piece of secondhand clothing to determine other attributes such as quality in order to determine whether a particular piece of secondhand clothing is salable or non-salable. If a particular piece of secondhand clothing is determined to have unacceptable quality, based on the trained employees' personal judgement, due to wear, damage, or other defects (e.g., holes, stains, etc.), it is typically non-salable and considered to be low-value waste (i.e., textile waste). In this regard, with manually handing and visually inspecting each piece of secondhand clothing, it is possible, even for trained employees working thoroughly and diligently, to overlook some wear, damage, or other defects (e.g., small holes, small stains, etc.). This is exacerbated by the fact that many trained employees manually handle and visually inspect vast amounts of secondhand clothing per day or week, making the process relatively tedious and time-consuming. If particular pieces of secondhand clothing are determined to be salable after being manually handled and visually inspected, trained employees then typically manually tag (i.e., sometimes with limited information other than a barcode and price) each piece of salable secondhand clothing, which takes even more time and often limits the daily number of salable pieces of secondhand clothing that can be processed and sent to a retail store sales floor or posted online for resale. When posting secondhand clothing online for resale, additional pictures of the secondhand clothing are also typically taken manually by trained employees, adding additional labor and time to the process.

Secondhand clothing and other secondhand textiles that are not resold via the secondary resale market (e.g., at retail or online stores of non-profit organizations or other entities) may be further utilized (e.g., resold, repurposed, repaired, or recycled) so as to extend their lifecycle, reduce textile waste, and provide a positive impact on the environment. For example, unsold secondhand clothing may be sold in bulk quantities to developing countries for resale. Alternatively, unsold secondhand clothing considered as textile waste may be chemically or mechanically recycled into raw materials that can be utilized to manufacture additional products (e.g., new clothing, textile fibers, high-value additives to enhance various material compositions of products, etc.). In this regard, in cases where such textile waste is accurately sorted by its accurately-determined material composition, the textile waste is often considered to be more suitable and valuable for chemically or mechanically recycling into raw materials. As such, textile waste represents a valuable waste stream that has the potential to be transformed into a wide range of products via specially designed technologies and equipment, further providing a positive impact on the environment.

Considering at least the above discussion, there is currently an unaddressed need for automated, small or large-scale processing of secondhand textiles (e.g., secondhand clothing), in a convenient, efficient, and accurate manner with minimal human interaction, that better enables such secondhand textiles to be further utilized (e.g., resold, repurposed, repaired, or recycled).

### SUMMARY

This section provides a general summary of the present disclosure and is not a comprehensive disclosure of its full scope or all of its features.

The present disclosure aims to address the aforementioned unaddressed need, as discussed above, for automated, small or large-scale processing of secondhand textiles that better enables such secondhand textiles to be further utilized. In this regard, at least one embodiment of the present disclosure advantageously provides at least a method of processing secondhand textiles for further utilization.

According to at least one embodiment, a method of processing secondhand textiles for further utilization includes providing a secondhand textile, inspecting and screening the secondhand textile, with at least inspection and screening hardware, to determine attribute data of the secondhand textile, analyzing the determined attribute data of the secondhand textile, and determining if the secondhand textile is salable or non-salable based on at least the analyzing of the determined attribute data of the secondhand textile.

According to at least one embodiment, the inspection and screening hardware may include at least one of a laser sensor, an infrared camera, an RGB sensor, X-Ray hardware, an ultraviolet (UV) camera, or image processing.

According to at least one embodiment, the determined attribute data of the secondhand textile may include at least one of size data, type data, seasonal data, color/pattern data, brand data, gender data, or quality data.

According to at least one embodiment, the analyzing of the determined attribute data of the secondhand textile may be carried out by at least one of an AI processor, AI software, or a programmable logic controller (PLC).

According to at least one embodiment, the determined attribute data of the secondhand textile may include at least quality data, and the determining if the secondhand textile is salable or non-salable may be based on at least the analyzing of the determined quality data of the secondhand textile.

According to at least one embodiment, the determined attribute data of the secondhand textile may include at least quality data, and the method may further include grading the secondhand textile, if determined to be salable, automatically with a numerical quality grade based on at least the analyzing of the determined quality data of the secondhand textile.

According to at least one embodiment, the method may further include obtaining tag data from a manufacturer tag of the secondhand textile, if the manufacturer tag is present, prior to at least the determining if the secondhand textile is salable or non-salable. The tag data may be obtained by detecting, scanning, or reading the manufacturer tag of the secondhand textile with scanning hardware or an RFID reader.

According to at least one embodiment, the method may further include determining material composition data of the secondhand textile prior to at least the determining if the secondhand textile is salable or non-salable, and tagging the secondhand textile, if determined to be salable, automatically with a resale tag having resale tag data generated based on at least the determined material composition data and the analyzing of the determined attribute data of the secondhand textile.

According to at least one embodiment, the method may further include determining material composition data of the secondhand textile prior to at least the determining if the secondhand textile is salable or non-salable, and sorting the secondhand textile, if determined to be non-salable, automatically based on the determined material composition data of the secondhand textile.

According to at least one embodiment, a method of processing secondhand textiles for further utilization includes providing a secondhand textile, inspecting and screening the secondhand textile, with at least inspection and screening hardware, to determine attribute data of the secondhand textile, analyzing the determined attribute data of the secondhand textile, and validating at least a determined overall pass/fail condition of the secondhand textile such that, if the overall pass/fail condition of the secondhand textile is validated as pass, the secondhand textile is determined to be salable, and if the overall pass/fail condition of the secondhand textile is validated as fail, the secondhand textile is determined to be non-salable.

According to at least one embodiment, the inspection and screening hardware may include at least one of a laser sensor, an infrared camera, an RGB sensor, X-Ray hardware, an ultraviolet (UV) camera, or image processing.

According to at least one embodiment, the determined attribute data of the secondhand textile may include at least one of size data, type data, seasonal data, color/pattern data, brand data, gender data, or quality data.

According to at least one embodiment, the analyzing of the determined attribute data of the secondhand textile may be carried out by at least one of an AI processor, AI software, or a programmable logic controller (PLC).

According to at least one embodiment, the determined attribute data of the secondhand textile may include at least quality data, and the determined overall pass/fail condition of the secondhand textile may be based on at least the analyzing of the determined quality data of the secondhand textile.

According to at least one embodiment, the determined attribute data of the secondhand textile may include at least quality data, and the method may further include grading the secondhand textile, if determined to be salable, automatically with a numerical quality grade based on at least the analyzing of the determined quality data of the secondhand textile.

According to at least one embodiment, the validating of at least the determined overall pass/fail condition of the secondhand textile may be carried out by the use of a human-machine interface (HMI).

According to at least one embodiment, the method may further include determining material composition data of the secondhand textile prior to validating at least the determined overall pass/fail condition of the secondhand textile, and tagging the secondhand textile, if determined to be salable, automatically with a resale tag having resale tag data generated based on at least the determined material composition data and the analyzing of the determined attribute data of the secondhand textile.

According to at least one embodiment, the method may further include communicating at least the resale tag data of the secondhand textile to an online store.

According to at least one embodiment, the method may further include determining material composition data of the secondhand textile prior to validating at least the determined overall pass/fail condition of the secondhand textile, and sorting the secondhand textile, if determined to be non-salable, automatically based on the determined material composition data of the secondhand textile.

According to at least one embodiment, a method of processing secondhand textiles for further utilization includes providing a secondhand textile, determining the secondhand textile is salable based on at least analyzing determined attribute data of the secondhand textile, the attribute data of the secondhand textile determined by at least inspection and screening hardware, and tagging the secondhand textile automatically with a resale tag having resale tag data generated based on at least the analyzing of the determined attribute data of the secondhand textile.

### BRIEF DESCRIPTION OF THE DRAWINGS

The present disclosure will become more fully understood from the detailed description and the accompanying drawings, wherein:

FIG. 1 is a flowchart schematically illustrating a method of processing secondhand textiles for further utilization, according to at least one embodiment;

FIG. 2 is a schematic diagram schematically illustrating a system for processing secondhand textiles for further utilization, according to at least one embodiment;

FIG. 3 is a schematic diagram schematically illustrating an operator loading a secondhand textile on an overhead conveyor of the system at a loading location of the system;

FIG. 4 are perspective views illustrating a carrying hanger of the overhead conveyor and a controlled actuator and movable retaining clip engagement member of the system which may automatically lock and/or release spring-loaded retaining clips of the carrying hanger;

FIG. 5 is a schematic diagram schematically illustrating an operator validating an overall pass/fail condition of the secondhand textile at an unloading location of the system;

FIG. 6 are views illustrating a target area for automated tagging of a secondhand textile with respect to a carrying hanger of the overhead conveyor, and labels and retainers which may be utilized in the automated tagging of a secondhand textile;

FIG. 7 is a schematic diagram schematically illustrating a carrying hanger of the conveyor releasing and dropping (i.e., unloading) a salable secondhand textile at the unloading location of the system; and

FIG. 8 is a schematic diagram schematically illustrating a carrying hanger of the conveyor releasing and dropping (i.e., unloading) a non-salable secondhand textile in a sorting bin at a rejection and sorting location of the system.

### DETAILED DESCRIPTION

As required, one or more detailed embodiments of the present disclosure are disclosed herein, however, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure. Furthermore, the use of a singular term, such as, “a” is not to be interpreted as limiting the number of components or details of particular components. Moreover, the use of the word “or” in reference to a list of two or more components or details covers all of the following interpretations of the word: any of the components or details in the list, all of the components or details in the list and any combination of the components or details in the list. Additionally, various terms and/or phrases describing or indicating a position or directional reference such as, but not limited to, “top”, “bottom”, “front”, “rear”, “forward”, “rearward”, “end”, “outer”, “inner”, “left”, “right”, “vertical”, “horizontal”, “upper”, “upwardly, “lower”, “downwardly”, etc. may relate to one or more particular components as seen generally from a user's vantage point during use or operation, and such terms and/or phrases are not to be interpreted as limiting, but merely as a representative basis for describing the present disclosure to one skilled in the art. Moreover, as one skilled in the art will understand, various features illustrated and described with reference to any one of the figures may be combined with features illustrated in one or more other figures to produce embodiments that are not explicitly illustrated or described herein. The combinations of features illustrated provide representative embodiments for typical applications. Various combinations and modifications of the features consistent with the teachings of this disclosure, however, could be desired for particular applications or implementations.

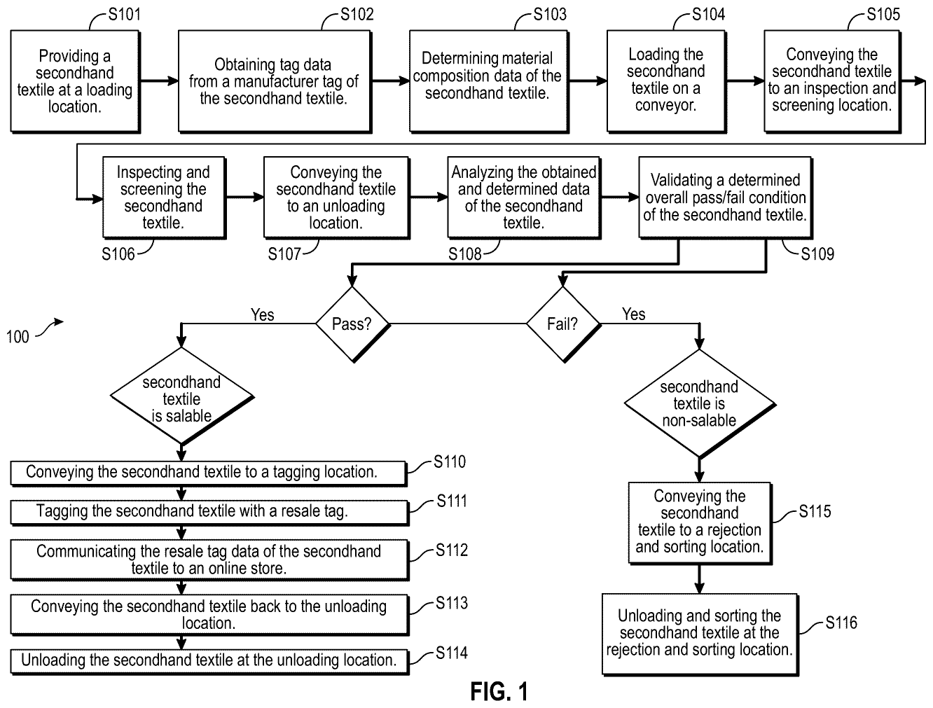

Referring generally to FIGS. 1-8, as will be further described herein in greater detail, at least one embodiment of the present disclosure provides a method 100 of processing secondhand textiles for further utilization. Additionally, at least one embodiment of the present disclosure provides a system 200 for processing secondhand textiles for further utilization, by which at least some or all steps of the method 100 may be practiced. As will become evident to those skilled in the art, the method 100 is advantageously capable of providing automated, small or large-scale processing of secondhand textiles, in a convenient, efficient, and accurate manner with minimal human interaction, that better enables such secondhand textiles to be further utilized (e.g., resold, repurposed, repaired, or recycled). In this regard, with such secondhand textiles being further utilized so as to extend their lifecycle, unutilized textile waste may be greatly reduced and positively impact the environment. Moreover, it is to be understood by those skilled in the art that the method 100 may be practiced in any desired or appropriate environment (e.g., in larger central sorting hubs or smaller backrooms of retail stores) and by any system, machine, equipment, etc. as desired or deemed appropriate. In this regard, the method 100 is not limited to being practiced by way of the system 200 described herein, as the system 200 described herein is merely intended to be illustrative.

Referring to FIG. 1, with regard to the method 100, while a single secondhand textile 400 will be referenced herein for purposes of describing the method 100 more clearly, it is to be understood that many secondhand textiles (e.g., 300-500 secondhand textiles per hour) may be processed (e.g., sequentially) by way of the method 100 in a similar or same manner as the referenced single secondhand textile 400. Moreover, for purposes of describing the disclosure, it is to be understood that a “secondhand” textile or “secondhand” textiles may include one or more used (i.e., previously worn) textiles and/or brand new (i.e., unused or unworn) textiles, such as previously owned by an individual or a company. Such secondhand textiles may be secondhand clothing or other secondhand textiles, as will be further described herein in greater detail.

The method 100 begins at step S101 thereof. According to at least one embodiment, step S101 may include providing a secondhand textile 400 at a loading location, such as at a loading location (e.g., loading station) 202 of the system 200. As non-limiting examples, the secondhand textile 400 may be provided at the loading location 202 by way of a separate bin, rack, conveyor, robot arm, etc. (e.g., manually by a trained employee or automated). Moreover, as a non-limiting example, the secondhand textile 400 may be a piece of secondhand clothing (e.g., donated by an individual or a company to a non-profit organization, etc.), such as a shirt, a blouse, a jacket, a pair of pants or shorts, a dress, a gown, a skirt, an undergarment, or other pieces of clothing and garments.

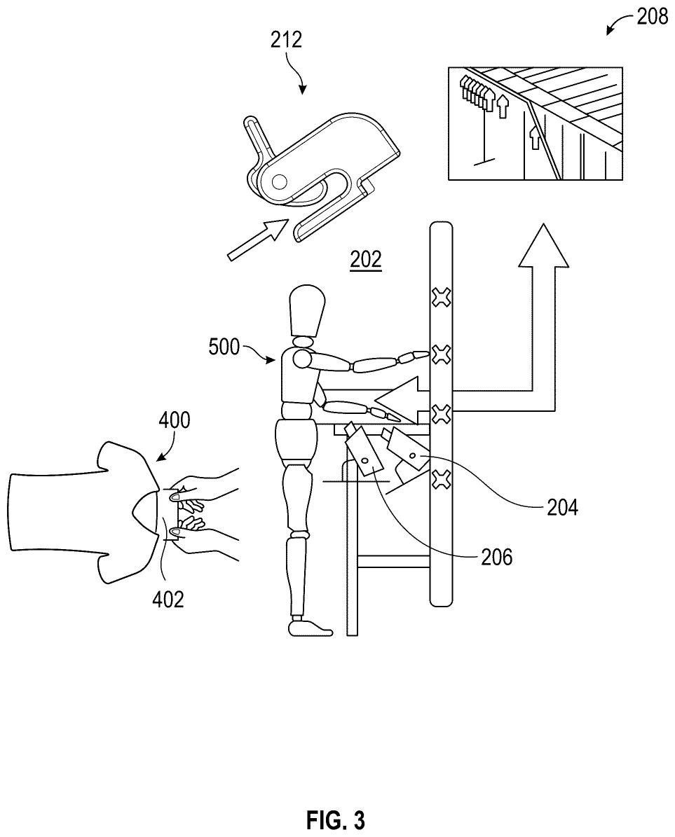

Once the secondhand textile 400 has been provided at the loading location 202 from step S101, the method 100 may proceed to step S102 thereof. According to at least one embodiment, step S102 may include obtaining tag data from a manufacturer tag 402 (i.e., if present) of the secondhand textile 400. More specifically, obtaining the tag data from the manufacturer tag 402 of the secondhand textile 400 may include detecting, scanning, or reading the manufacturer tag 402 (i.e., if present), including a barcode of the manufacturer tag 402 (i.e., if present), of the secondhand textile 400 to obtain the tag data. As non-limiting examples, such tag data may include various attributes (i.e., attribute data) of the secondhand textile 400, such as material composition data (e.g., cotton, synthetic, mix, etc.), brand data, size data, and gender data. Moreover, as a non-limiting example, the manufacturer tag 402 of the secondhand textile 400 may be detected and scanned by image scanning hardware, such as a camera 204 of the system 200 at the loading location 202, as illustrated in FIG. 3. In this regard, as further illustrated in FIG. 3, an operator (e.g., a trained employee) 500 may hold the secondhand textile 400 in a horizonal orientation such that the manufacturer tag 402 of the secondhand textile 400 may be detected and scanned by the camera 204 at the loading location 202.

Alternatively, if the secondhand textile 400 manufacturer tag 402 includes a tag chip (e.g., an RFID tag chip), hardware such as an RFID reader may be utilized to obtain the tag data from the manufacturer tag 402 of the secondhand textile 400 at a further distance away from the secondhand textile 400.

As non-limiting examples, the obtained tag data from the manufacturer tag 402 of the secondhand textile 400 may be processed by artificial intelligence (AI) sources to build AI databases and a neural net system that may enable machine learning for equipment or components of the system 200. In this regard, as non-limiting examples, a scanned image (i.e., obtained by the camera 204) of the manufacturer tag 402 of the secondhand textile 400 may be communicated to AI image processing software and may be processed by cloud-based systems, or by on-premises neural network devices, etc.

In such a case where the secondhand textile 400 does not contain a manufacturer tag, or the manufacturer tag 402 is unreadable, the method may proceed to step S103 without obtaining tag data from a manufacturer tag. As will become evident to those skilled in the art when considering subsequent steps of the method 100 described later herein, the method 100 is advantageously capable of still determining such aforementioned data (i.e., attribute data) of the secondhand textile 400 that would typically be listed on the manufacturer tag, even if the secondhand textile 400 does not contain a manufacturer tag or the manufacturer tag is unreadable.

Once the tag data from the manufacturer tag 402 (i.e., if present) of the secondhand textile 400 is obtained or not obtained from step S102, the method 100 may proceed to step S103 thereof. According to at least one embodiment, step S103 may include determining material composition data of the secondhand textile 400. More specifically, determining the material composition data of the secondhand textile 400 may include scanning the secondhand textile 400 to determine the material composition data thereof, as illustrated in FIG. 3. As a non-limiting example, the secondhand textile 400 may be scanned by a sensor, such as a near infrared (NIR) sensor (i.e., spectral sensor) 206 of the system 200 at the loading location 202, as illustrated in FIG. 3. In this regard, as further illustrated in FIG. 3, the operator (e.g., a trained employee) 500 may hold the secondhand textile 400 in a horizonal orientation such that the material of the secondhand textile 400 may be scanned by the NIR sensor 206 at the loading location 202. In this regard, as a non-limiting example, the material composition data of the secondhand textile 400 may be determined by NIR spectroscopy utilizing a comprehensive NIR composition database. As non-limiting examples, the NIR composition database may include such material composition data as “51% cotton, 49% other synthetic fiber”, “50% cotton, 50% other synthetic fiber”, “100% wool”, and numerous other material composition data. As such, it is advantageously possible to accurately determine the material composition data (i.e., material composition) of the secondhand textile 400 by scanning the material thereof with the NIR sensor 206, as the determined material composition data of the secondhand textile 400 may be even more accurate than material composition data listed on the manufacturer tag 402 of the secondhand textile 400.

While step S103 is described above as succeeding step S102 of the method 100, step S103 may be practiced simultaneously with step S102, or prior to step S102, as may be understood by those skilled in the art.

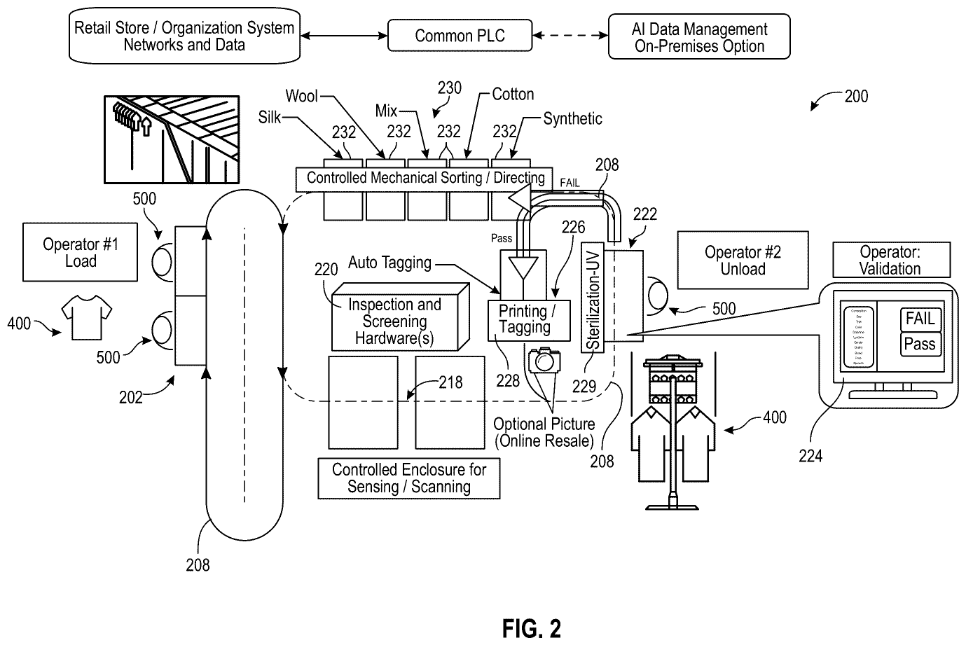

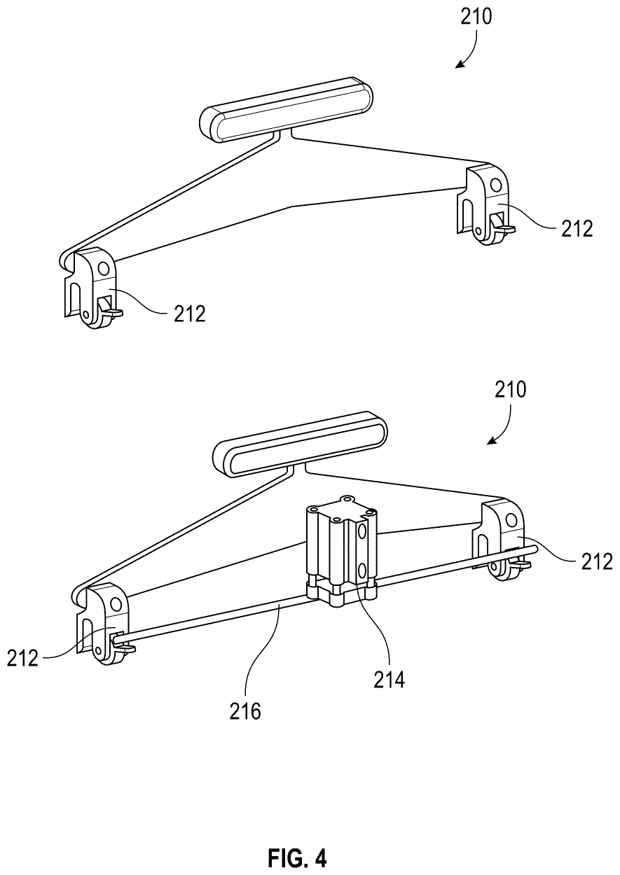

Once the material composition data of the secondhand textile 400 has been determined from step S103, the method 100 may proceed to step S104 thereof. According to at least one embodiment, step S104 may include loading the secondhand textile 400 on a conveyor, such as a conveyor 208 of the system 200. As non-limiting examples, the conveyor 208 may be a vertical (e.g., climbing) conveyor, horizontal belt conveyor, an overhead conveyor, or combinations thereof. In the non-limiting example illustrated in at least FIGS. 2-4 and 6-8, the conveyor 208 is an overhead conveyor which may advantageously keep motion safe for operators and bystanders. As illustrated in at least FIG. 4, the conveyor 208 may include a carrying hanger 210, and more specifically a number (e.g., several hundred) of carrying hangers 210 that are each capable of securely retaining and carrying a secondhand textile 400 on the conveyor 208. As a non-limiting example, each carrying hanger 210 of the conveyor 208 may include rotatable spring-loaded retaining clips 212 which may be advantageously locked (i.e., fastened down or closed) and released (i.e., opened) automatically by a controlled actuator 214 and movable retaining clip engagement member (e.g., a rod) 216 of the system 200, such as at the loading, unloading, and rejection and sorting locations of the system 200. As further illustrated in at least FIG. 3, the operator (e.g., trained employee) 500 at the loading location 202 of the system 200 may place the secondhand textile 400 in the spring-loaded retaining clips 212 of the carrying hanger 210 in a generally horizontal orientation for improved ergonomics, and the spring-loaded retaining clips 212 may then be automatically locked and secured by the actuator 214 and movable retaining clip engagement member 216 of the system 200, thereby securely retaining (i.e., loading) the secondhand textile 400 on the carrying hanger 210 of the conveyor 208. The conveyor 208 may then rotate or move the loaded secondhand textile 400 retained on the carrying hanger 210 of the conveyor 208 to an upright (i.e., vertical hanging) orientation to be conveyed to other locations of the system 200 in a controlled manner, as may be understood by those skilled in the art.

Once the secondhand textile 400 has been loaded on the conveyor 208 from step S104, the method 100 may proceed to step S105 thereof. According to at least one embodiment, step S105 of the method 100 may include conveying the secondhand textile 400 to an inspection and screening location, such as to an inspection and screening location (e.g., an inspection and screening station) 218 of the system 200. The conveying of the secondhand textile 400 to the inspection and screening location 218 may be carried out by the conveyor 208 of the system 200 in a controlled manner, as may be understood by those skilled in the art.

Once the secondhand textile 400 has been conveyed to the inspection and screening location 218 from step S105, the method 100 may proceed to step S106 thereof. According to at least one embodiment, step S106 may include inspecting and screening the secondhand textile 400 at the inspection and screening location 218 of the system 200. More specifically, inspecting and screening the secondhand textile 400 may include inspecting and screening the secondhand textile 400 to determine various attribute data (i.e., attributes) of the secondhand textile 400. As non-limiting examples, such determined attribute data of the secondhand textile 400 may include size data (e.g., size of clothing such as small, medium, large, extra-large, etc.), type data (e.g., type of clothing such as pants, shirt, dress etc.), seasonal data (e.g., summer clothing, winter clothing, etc.), color/pattern data (e.g., color/pattern of clothing), brand data (e.g., brand of clothing), gender data (e.g., clothing for male, female, child, unisex), and quality data (i.e., determination and representation of the quality of the clothing, which may also be used for numerically grading the quality of the clothing, based on at least detecting wear, stains, defects, holes, non-fabric material, etc.). As a non-limiting example, such attribute data of the secondhand textile 400 may be determined by at least inspection and screening hardware 220 at the inspection and screening location 218, which may be in a controlled enclosure for sensing and scanning the secondhand textile 400. More specifically, as non-limiting examples, the inspection and screening hardware 220 may include at least one of a laser sensor for sensing the secondhand textile 400 to determine size data of the secondhand textile 400, a camera for scanning an image of the secondhand textile 400 to determine size data, type data, seasonal data, color/pattern data, or brand data (e.g., logo recognition) of the secondhand textile 400, an RGB sensor for sensing the secondhand textile 400 to determine color/pattern data of the secondhand textile 400, X-Ray hardware for scanning the secondhand textile 400 to determine the quality data of the secondhand textile 400 and to identify non-fabric (e.g., metal, plastic) accessories (e.g., zippers, buttons, etc.) of the secondhand textile 400, an ultraviolet (UV) camera for scanning the secondhand textile 400 to determine the quality data, which may also be used for numerically grading quality of the secondhand textile 400, an infrared camera for scanning an image of the secondhand textile 400 to determine or detect defects (e.g., stains, etc.) relating to the quality data of the secondhand textile 400, and image processing for colors (i.e., color data), patterns (i.e., pattern data), brands (i.e., brand data), quality data (e.g., defects, holes), etc. As non-limiting examples, the scanned images and sensed (i.e., determined) attribute data of the secondhand textile 400 from the inspection and screening hardware 220 may be communicated to AI image processing software and may be processed by cloud-based systems, or by on-premises devices, such as neural network devices, etc.

Once the secondhand textile 400 has been inspected and screened from step S106, the method 100 may proceed to step S107 thereof. According to at least one embodiment, step S107 of the method 100 may include conveying the secondhand textile 400 to an unloading location, such as to an unloading location (e.g., unloading station) 222 of the system 200. The conveying of the secondhand textile 400 to the unloading location 222 may be carried out by the conveyor 208 of the system 200 in a controlled manner, as may be understood by those skilled in the art.

Once the secondhand textile 400 has been conveyed to the unloading location 222 from step S107, the method 100 may proceed to step S108 thereof. According to at least one embodiment, step S108 may include analyzing the obtained and determined data of the secondhand textile 400. More specifically, analyzing the obtained and determined data of the secondhand textile 400 may include analyzing at least one or more of the tag data obtained in step S102 (i.e., if obtained), the material composition data determined in step S103 (i.e., if determined), and the determined attribute data of the secondhand textile 400 determined in step S106. As non-limiting examples, the analyzing of the obtained and determined data of the secondhand textile 400 may be carried out by an AI processor, AI software, a programmable logic controller (PLC), etc. In this regard, the obtained and determined data of the secondhand textile 400 may be collected into a database to serve the AI for processing and determining various conclusions (i.e., decision making). As such, the analyzing of the obtained and determined data of the secondhand textile 400 may advantageously determine (i.e., at least initially determine or conclude) at least: if the secondhand textile 400 is salable (i.e., having acceptable quality meeting at least a minimum quality threshold), if the secondhand textile 400 is non-salable (i.e., having unacceptable quality due to defects such as wear, stains, holes, etc., and not meeting at least the minimum quality threshold), and any obtained and determined data to be included (i.e., printed or encoded) on a resale tag of a salable secondhand textile 400 (i.e., further discussed later herein), such as material composition data, or determined attribute data such as size data, type data, seasonal data, color data, pattern data, gender data, quality data, numerical quality grade data, brand data, price data, barcode data, date/time data, location data (i.e., of store or region of sale), etc. Additionally, the analyzing of the obtained and determined data of the secondhand textile 400 may further focus on analyzing the determined attribute data, including at least the determined quality data, of the secondhand textile 400 determined in step S106 so as to determine an overall pass/fail condition of the secondhand textile 400 to be further validated later (i.e., such as by an operator 500), as will be further discussed herein. Moreover, the analyzing of at least the determined quality data of the secondhand textile 400 determined in step S106 may advantageously be utilized for numerically grading the secondhand textile 400 for quality, if determined to be salable, automatically with a numerical quality grade based on at least the analyzing of the determined quality data of the secondhand textile 400. In this regard, as a non-limiting example, the determined numerical quality grade of the salable secondhand textile 400 may be from 1-5, with 1 designating the lowest (i.e., worst) quality grade, and 5 designating the highest (i.e., best) quality grade. As will be discussed later herein, such determined numerical quality grades for the secondhand textile 400, if determined to be salable, are advantageous for determining a particular value/selling price of the secondhand textile 400, and for sorting salable textiles 400 based on such numerical quality grades.

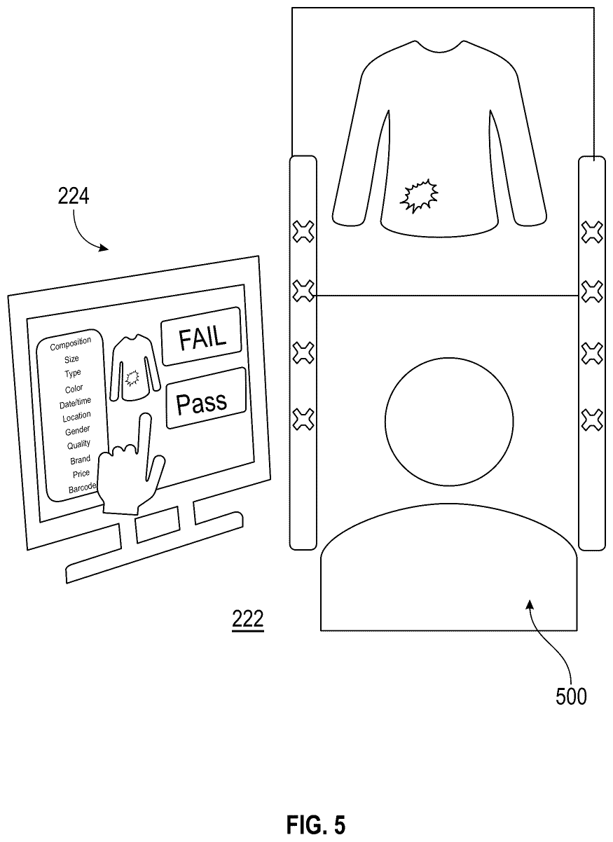

Once the obtained and determined data of the secondhand textile 400 has been analyzed from step S108, the method 100 may proceed to step S109 thereof. According to at least one embodiment, step S109 may include validating a determined overall pass/fail condition of the secondhand textile 400. In this regard, as previously described herein, the determined overall pass/fail condition of the secondhand textile 400 may be determined by or based on at least the analyzing of the obtained and determined data of the secondhand textile 400 (i.e., from step S108). As illustrated in FIGS. 2 and 5, as a non-limiting example, a human-machine interface (HMI) (e.g., which may be AI-based and may include a display or touch screen) 224 of the system 200 may be provided at the unloading location 222. The HMI 224 may advantageously display each obtained and determined data (i.e., material composition data, size data, type, season data, color data, pattern data, gender data, quality data, numerical quality grade data, brand data, price data, barcode data, date/time data, location data, etc.) of the secondhand textile 400 and the determined overall pass/fail condition of the secondhand textile 400. Moreover, images obtained from the inspection and screening hardware 220 at the inspection and screening location 218 (i.e., from step S106) may be displayed at the HMI 224. An operator (e.g., trained employee) 500 may visually inspect the secondhand textile 400 for comparison with images of the secondhand textile 400 displayed at the HMI 224. The operator 500 may also validate each displayed obtained and determined data of the secondhand textile 400, as well as validate the determined overall pass/fail condition of the secondhand textile 400. If the determined overall pass/fail condition of the secondhand textile 400 is validated as “pass” by the operator 500, the secondhand textile 400 is ultimately determined to be salable, and the method 100 may proceed to step S110 thereof. If the determined overall pass/fail condition of the secondhand textile 400 is validated as “fail” by the operator 500, the secondhand textile 400 is rejected and ultimately determined to be non-salable (i.e., considered as textile waste), and the method 100 may proceed to step S115 thereof, described later herein.

As previously described herein, if the determined overall pass/fail condition of the secondhand textile 400 is validated as “pass” (i.e., the secondhand textile 400 is determined to be salable) from step S109, the method 100 may proceed to step S110 thereof. According to at least one embodiment, step S110 of the method 100 may include conveying (e.g., in a loop) the secondhand textile 400 to a tagging location, such as to a tagging location (e.g., tagging station) 226 of the system 200. The conveying of the secondhand textile 400 to the tagging location 226 may be carried out by the conveyor 208 of the system 200 in a controlled manner, as may be understood by those skilled in the art.

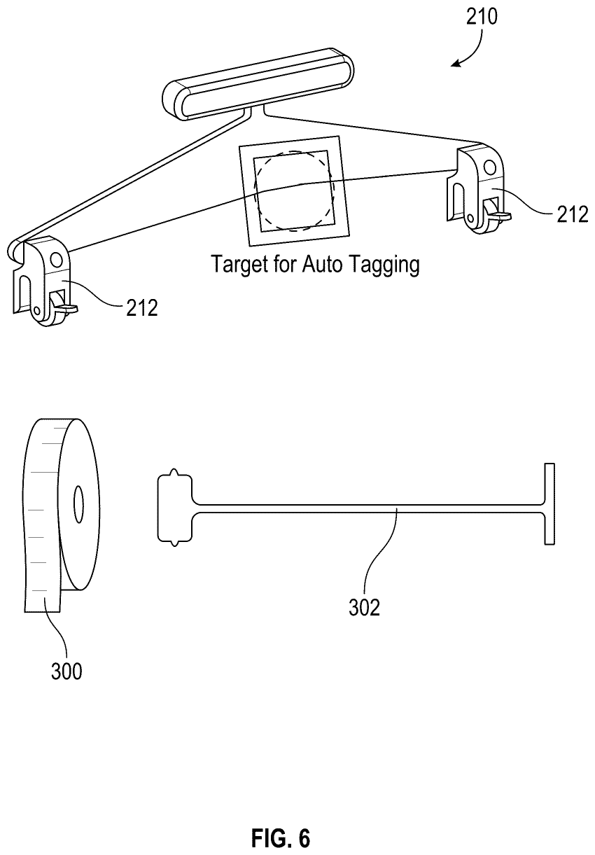

Once the secondhand textile 400 has been conveyed to the tagging location 226 from step S110, the method 100 may proceed to step S111 thereof. According to at least one embodiment, step S111 may include tagging the secondhand textile 400, automatically, with a resale tag. More specifically, the tagging of the secondhand textile 400 with the resale tag may advantageously be automated, and may be carried out by various automated printing and tagging hardware 228 of the system 200 provided at the tagging location 226. A label of the resale tag, such as provided from a label roll 300 (illustrated in FIG. 6), may be printed by the automated printing and tagging hardware 228. In this regard, the automated printing and tagging hardware 228 may print resale tag data on the label of the resale tag that is generated based on at least the previously-determined material composition data and/or the analyzing of the determined attribute data of the secondhand textile 400. As such, the resale tag data (e.g., material composition data, size data, type data, seasonal data, color data, pattern data, gender data, quality data, numerical quality grade data, brand data, price data, barcode data, date/time data, location data, etc.) may be advantageously provided and printed on the label of the resale tag quickly and conveniently. Moreover, the automated printing and tagging hardware 228 may adhere the printed label of the resale tag to a retainer 302 (illustrated in FIG. 6) of the resale tag, and fasten the retainer 302 of the resale tag to the secondhand textile 400. Alternatively, the resale tag of the secondhand textile 400 may include an RFID resale tag chip, rather than a printed label, that stores the resale tag data therein.

Once the secondhand textile 400 has been tagged with the resale tag from step S111, the method 100 may proceed to step S112 thereof. According to at least one embodiment, step S112 may include communicating the resale tag data of the secondhand textile 400 to an online store (e.g., an online store of a non-profit organization or other entity which resells secondhand textiles 400). More specifically, at least the previously-described resale tag data that may be printed on the label of the resale tag or stored in an RFID resale tag chip may be communicated to the online store (e.g., by way of retail store/organization system networks, etc.). It is to be further understood that the communication with the online store may also be carried out simultaneously with the automated tagging of the secondhand textile 400 from step S111.

Optionally, a picture (i.e., photo) of the secondhand textile 400 may be obtained and also communicated directly or indirectly to the online store, such as after the secondhand textile 400 is tagged with the resale tag. More specifically, as a non-limiting example, a professional photobooth or chamber of the system 200 having controlled lighting and one or more cameras may be provided at or near the tagging location 226 or other location to obtain one or more pictures (i.e., photos) of the secondhand textile 400 which may be communicated directly or indirectly to the online store.

Once the resale tag data of the resale tag of the secondhand textile 400 is communicated to the online store from step S112, the method 100 may proceed to step S113 thereof. According to at least one embodiment, step S113 of the method 100 may include conveying (e.g., in a loop) the secondhand textile 400 back to the unloading location 222 of the system 200. The conveying of the secondhand textile 400 back to the unloading location 222 may be carried out by the conveyor 208 of the system 200 in a controlled manner, as may be understood by those skilled in the art.

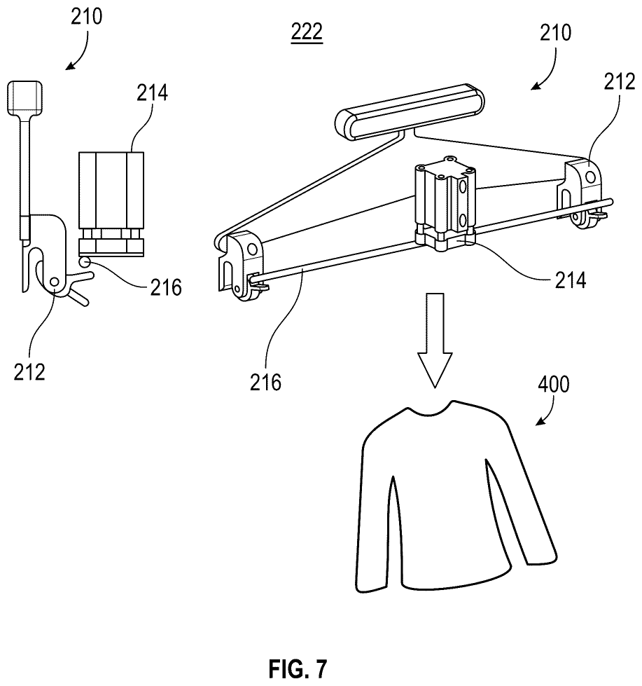

Once the secondhand textile 400 has been conveyed back to the unloading location 222 from step S113, the method 100 may proceed to step S114 thereof. According to at least one embodiment, step S114 may include unloading the secondhand textile 400 at the unloading location 222 of the system 200. More specifically, as illustrated in FIG. 7, the controlled actuator 214 and movable retaining clip engagement member 216 of the system 200 may advantageously be controlled to automatically release (i.e., open) the spring-loaded retaining clips 212 of the carrying hanger 210 of the conveyor 208 to automatically release and drop (i.e., unload) the secondhand textile 400 at the unloading location 222.

Once the salable secondhand textile 400 is unloaded, as a non-limiting example, the operator (e.g., trained employee) 500 at the unloading location 222 may then manually transfer the salable secondhand textile 400 to a salable hanger, salable rack, or salable storage bin apart from the system 200.

Alternatively, instead of the operator (e.g., trained employee) 500 manually transferring the secondhand textile 400 at the unloading location 222, as a non-limiting example, the controlled actuator 214 and movable retaining clip engagement member 216 of the system 200 may advantageously be controlled to automatically release (i.e., open) the spring-loaded retaining clips 212 of the carrying hanger 210 of the conveyor 208 to automatically release and drop (i.e., unload) the secondhand textile 400 into one of a plurality of sorting bins (not shown) at the unloading location 222 to sort the secondhand textile 400. In this regard, as a non-limiting example, the carrying hanger 210 of the conveyor 208 may automatically convey over and drop the secondhand textile 400 into one of the plurality of sorting bins based on the previously-determined attribute data of the secondhand textile 400. Further in this regard, as non-limiting examples, each individual sorting bin may be designated to receive salable secondhand textiles 400 having particular attribute data, such as particular quality data (e.g., numerical quality grade data 1-5), size data, type data, season data, color data, brand data, etc.

Optionally, the salable secondhand textile 400 may be sterilized (i.e., sanitized) prior to, during, or after being unloaded at the unloading location 222. As a non-limiting example, the secondhand textile 400 may be sterilized by a timed exposure to sterilization hardware (e.g., a UV light) 229 of the system 200 provided at or near the unloading location 222. It is to be understood, however, that the sterilization hardware 229 may be provided at any desired or appropriate location of the system 200, and therefore the sterilization of the secondhand textile 400 may occur at various other steps of the method 100 described herein.

The salable secondhand textile 400, along with vast amounts of other salable secondhand textiles 400 processed by way of the method 100 and system 200, may then be sent or shipped (e.g., by way of various containers, racks, shipping methods, etc.) to various other locations off or on-premises, such as a warehouse, distribution center, store, or sales floor thereof for resale. In this regard, if the system 200 is located in a store (e.g., backroom), at least some of the salable secondhand textiles 400 may remain on-premises and be sent to the sales floor of the store. Moreover, since the method 100 and system 200 described herein are advantageously capable of manually and/or automatically sorting salable secondhand textiles 400 based on their previously-determined attributes (e.g., numerical quality grade data 1-5, size data, type data, season data, color data, brand data, etc.), a higher value of such secondhand textiles 400 may be realized, thereby allowing salable secondhand textiles 400 with higher-graded quality, high-value brand recognition, etc. to be resold at a higher price.

As previously described herein, if the determined overall pass/fail condition of the secondhand textile 400 is validated as “fail” (i.e., the secondhand textile 400 is rejected and determined to be non-salable and considered as textile waste) from step S109, the method 100 may proceed to step S115 thereof. According to at least one embodiment, step S115 of the method 100 may include conveying the secondhand textile 400 to a rejection and sorting location, such as to a rejection and sorting location (e.g., rejection and sorting station) 230 of the system 200. The conveying of the secondhand textile 400 to the rejection and sorting location 230 may be carried out by the conveyor 208 of the system 200 in a controlled manner, as may be understood by those skilled in the art.

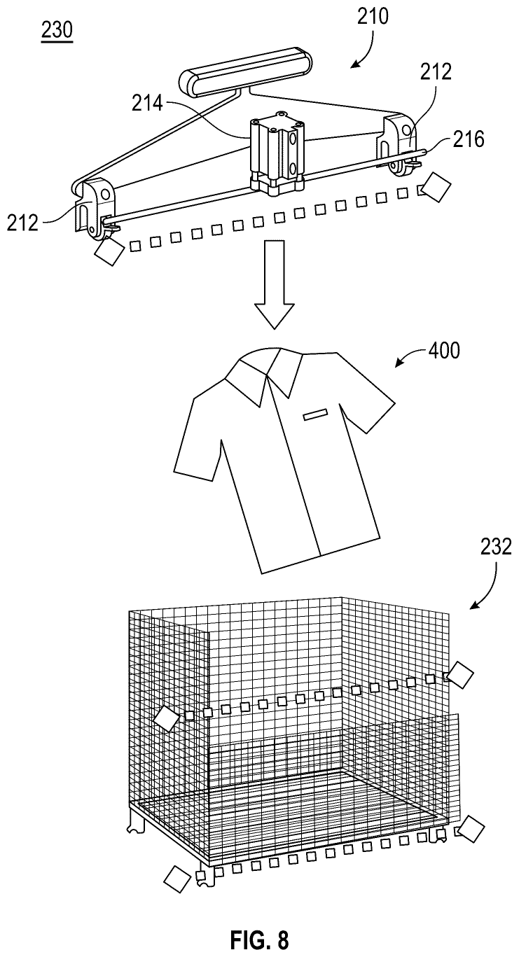

Once the secondhand textile 400 has been conveyed to the rejection and sorting location 230 from step S115, the method 100 may proceed to step S116 thereof. According to at least one embodiment, step S116 may include unloading and sorting the secondhand textile 400 at the rejection and sorting location 230 of the system 200. More specifically, as a non-limiting example, as illustrated in FIG. 8, the controlled actuator 214 and movable retaining clip engagement member 216 of the system 200 may advantageously be controlled to automatically release (i.e., open) the spring-loaded retaining clips 212 of the carrying hanger 210 of the conveyor 208 to automatically release and drop (i.e., unload) the secondhand textile 400 into one of a plurality of sorting bins 232 at the rejection and sorting location 230 to automatically sort the secondhand textile 400. In this regard, as a non-limiting example, the carrying hanger 210 of the conveyor 208 may automatically convey over and drop the secondhand textile 400 into one of the plurality of sorting bins 232 based on the previously-determined material composition data of the secondhand textile 400. Further in this regard, as non-limiting examples, each individual sorting bin 232 may be designated to receive secondhand textiles 400 of a particular material composition, such as synthetic (e.g., polyester), cotton, mix, wool, and silk.

As may be appreciated by those skilled in the art, the sorted non-salable secondhand textile 400, along with vast amounts of other sorted non-salable secondhand textiles 400 (i.e., sorted textile waste) processed by way of the method 100 and system 200, may then be sent or shipped to various locations off premises from the system 200 (e.g., by way of various containers, shipping methods, etc.) to be repaired, repurposed, or deconstructed and recycled into raw materials that can be utilized to manufacture additional products. Moreover, since the method 100 and system 200 described herein are advantageously capable of automatically and accurately sorting non-salable secondhand textiles 400 (i.e., textile waste) based on their material composition data, recyclers are further benefited by receiving such accurately-sorted non-salable textiles (i.e., textile waste).

While one or more embodiments are described above, it is not intended that the one or more embodiments describe all possible forms encompassed by the claims. The words used in the specification are words of description rather than limitation, and it is understood that various changes may be made without departing from the spirit and scope of the disclosure. As previously described herein, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those skilled in the art will recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

With regard to any methods, processes, etc., described herein, it should be understood that, although the steps of such methods, processes, etc. have been described as occurring according to a certain ordered sequence, such methods, processes, etc. could be practiced with the described steps performed in an order other than the order described herein. It should be further understood that certain steps could be performed simultaneously, that other steps could be added, or that certain steps described herein could be omitted. In other words, the descriptions of any methods, processes, etc. described above are provided for the purpose of illustrating certain embodiments, and should in no way be construed so as to limit the claims.

As used in this specification and claims, the terms “for example”/(“e.g.”), “for instance”, “such as”, and “like”, and the verbs “comprising”, “having”, “including”, and their other verb forms, when used in conjunction with a listing of one or more carriers or other items, are each to be construed as open-ended, meaning that the listing is not to be considered as excluding other, additional carriers or items. Other terms are to be construed using their broadest reasonable meaning unless they are used in a context that requires a different interpretation.

What is claimed is:

1. A method of processing secondhand textiles for further utilization, the method comprising:
providing a secondhand textile;
inspecting and screening the secondhand textile, with at least inspection and screening hardware, to determine attribute data of the secondhand textile;
analyzing the determined attribute data of the secondhand textile; and
determining if the secondhand textile is salable or non-salable based on at least the analyzing of the determined attribute data of the secondhand textile.

2. The method according to claim 1, wherein the inspection and screening hardware includes at least one of a laser sensor, an infrared camera, an RGB sensor, X-Ray hardware, an ultraviolet (UV) camera, or image processing.

3. The method according to claim 1, wherein the determined attribute data of the secondhand textile includes at least one of size data, type data, seasonal data, color/pattern data, brand data, gender data, or quality data.

4. The method according to claim 1, wherein the analyzing of the determined attribute data of the secondhand textile is carried out by at least one of an AI processor, AI software, or a programmable logic controller (PLC).

5. The method according to claim 1, wherein the determined attribute data of the secondhand textile includes at least quality data, and wherein the determining if the secondhand textile is salable or non-salable is based on at least the analyzing of the determined quality data of the secondhand textile.

6. The method according to claim 1, wherein the determined attribute data of the secondhand textile includes at least quality data, the method further comprising:
grading the secondhand textile, if determined to be salable, automatically with a numerical quality grade based on at least the analyzing of the determined quality data of the secondhand textile.

7. The method according to claim 1, further comprising:
obtaining tag data from a manufacturer tag of the secondhand textile, if the manufacturer tag is present, prior to at least the determining if the secondhand textile is salable or non-salable, wherein the tag data is obtained by detecting, scanning, or reading the manufacturer tag of the secondhand textile with scanning hardware or an RFID reader.

8. The method according to claim 1, further comprising:
determining material composition data of the secondhand textile prior to at least the determining if the secondhand textile is salable or non-salable; and
tagging the secondhand textile, if determined to be salable, automatically with a resale tag having resale tag data generated based on at least the determined material composition data and the analyzing of the determined attribute data of the secondhand textile.

9. The method according to claim 1, further comprising:
determining material composition data of the secondhand textile prior to at least the determining if the secondhand textile is salable or non-salable; and
sorting the secondhand textile, if determined to be non-salable, automatically based on the determined material composition data of the secondhand textile.

10. A method of processing secondhand textiles for further utilization, the method comprising:
providing a secondhand textile;
inspecting and screening the secondhand textile, with at least inspection and screening hardware, to determine attribute data of the secondhand textile;
analyzing the determined attribute data of the secondhand textile; and
validating at least a determined overall pass/fail condition of the secondhand textile such that, if the overall pass/fail condition of the secondhand textile is validated as pass, the secondhand textile is determined to be salable, and if the overall pass/fail condition of the secondhand textile is validated as fail, the secondhand textile is determined to be non-salable.

11. The method according to claim 10, wherein the inspection and screening hardware includes at least one of a laser sensor, an infrared camera, an RGB sensor, X-Ray hardware, an ultraviolet (UV) camera, or image processing.

12. The method according to claim 10, wherein the determined attribute data of the secondhand textile includes at least one of size data, type data, seasonal data, color/pattern data, brand data, gender data, or quality data.

13. The method according to claim 10, wherein the analyzing of the determined attribute data of the secondhand textile is carried out by at least one of an AI processor, AI software, or a programmable logic controller (PLC).

14. The method according to claim 10, wherein the determined attribute data of the secondhand textile includes at least quality data, and wherein the determined overall pass/fail condition of the secondhand textile is based on at least the analyzing of the determined quality data of the secondhand textile.

15. The method according to claim 10, wherein the determined attribute data of the secondhand textile includes at least quality data, the method further comprising:
grading the secondhand textile, if determined to be salable, automatically with a numerical quality grade based on at least the analyzing of the determined quality data of the secondhand textile.

16. The method according to claim 10, wherein the validating of at least the determined overall pass/fail condition of the secondhand textile is carried out by the use of a human-machine interface (HMI).

17. The method according to claim 10, further comprising:
determining material composition data of the secondhand textile prior to validating at least the determined overall pass/fail condition of the secondhand textile; and
tagging the secondhand textile, if determined to be salable, automatically with a resale tag having resale tag data generated based on at least the determined material composition data and the analyzing of the determined attribute data of the secondhand textile.

18. The method according to claim 17, further comprising:
communicating at least the resale tag data of the secondhand textile to an online store.

19. The method according to claim 10, further comprising:
determining material composition data of the secondhand textile prior to validating at least the determined overall pass/fail condition of the secondhand textile; and
sorting the secondhand textile, if determined to be non-salable, automatically based on the determined material composition data of the secondhand textile.

20. A method of processing secondhand textiles for further utilization, the method comprising:
providing a secondhand textile;
determining the secondhand textile is salable based on at least analyzing determined attribute data of the secondhand textile, the attribute data of the secondhand textile determined by at least inspection and screening hardware; and
tagging the secondhand textile automatically with a resale tag having resale tag data generated based on at least the analyzing of the determined attribute data of the secondhand textile.
